(19) United States
(12) Patent Application Publication
(10) Pub. No.: US 2002/0120935 A1
(43) Pub. Date: Aug. 29, 2002

(54) Interactive order system for television and streaming media

(76) Inventors: Thomas Huber, Parker, CO (US); Thomas Lemmons, Evergreen, CO (US); Ian Zenoni, Highlands Ranch, CO (US)

Correspondence Address: The Law Offices of William W. Cochran, LLC, Suite 230, 3555 Stanford Road, Fort Collins, CO, 80525, US

(21) Appl. No.: 10/076,949

(22) Filed: Feb. 12, 2002

Related U.S. Application Data
(60) Provisional application No. 60/268,351, filed on Feb. 12, 2001.

(51) Int. Cl. H04N 7/16; G06F 17/60; H04N 7/025; H04N 7/10; G06F 3/00; H04N 5/445; G06F 13/00

(52) U.S. Cl. 725/60; 725/34; 725/1; 705/26; 725/46

(57) ABSTRACT

In an interactive media system including interactive TV and interactive streaming media systems, a software program performs a check to determine if a product advertised is available in different versions. If different versions of the product are available, a software program employs a database of preferences to identify a product that matches or most closely matches preferences. CRM systems can be used to collect and control the preference information, product information, including a preference specific version, if available, is displayed. An icon supporting single action ordering is displayed contingent upon the presence of billing and shipping information. Demographic information may be combined with customer preference information to identify advertisement types and versions. Advertisements may be associated with images contained in a program or advertisement of an interactive media presentation.

### CROSS REFERENCE TO RELATED APPLICATIONS

This application is based upon and claims the benefit of U.S. provisional application No. 60/268,351, entitled “INTERACTIVE ORDER SYSTEM FOR TELEVISION AND STREAMING MEDIA, filed Feb. 12, 2001 by Thomas Huber and Thomas Lemmons, the entire disclosure of which is herein specifically incorporated by reference for all that it discloses and teaches.

### BACKGROUND OF THE INVENTION

a. Field of Invention

The present invention pertains generally to television and streaming media and more specifically to an improved method of offering products for sale and for ordering products or services interactively with a televised or streaming media image.

b. Description of the Background

Interactive television, as may be realized through cable, Internet connection, satellite system, terrestrial broadcast, or broadcast methods, provides an opportunity for viewers to order merchandise displayed in advertising messages. An advertising message may include a displayed icon or menu items that a viewer may select to order a product. Ordering a product may involve selecting a version of the product suited to the viewer. For example, when purchasing a sweater, the viewer may select size and color. If ordering a pizza, the viewer may select pizza size, crust type and toppings, plus any additional items that may be offered in combination, such as soft drinks. The amount of interaction and time required to enter this information can be considerable, especially if a product is available in many different versions, or if information is entered using a remote control device. The complexity of ordering a product may limit the number of buyers. Remote control devices typically do not support direct alphanumeric entry and may require many button entries to provide product selection and ordering information. If the time expended ordering a product extends beyond the duration of an advertisement, the viewer may choose to abandon an order to return to viewing a program. Further, if a viewer orders a same product a number of times, as may be the case for food items, repeated entering of the same information may cause customer frustration and reduced order rates.

In order for advertising to be effective, it is desired that information relevant to the consumer be presented and that ordering of products be supported in an easy and convenient manner. Therefore, a new method of presenting advertising and servicing customer orders is needed.

### SUMMARY OF THE INVENTION

The present invention overcomes the disadvantages and limitations of the prior art by providing a system and method for advertising products and/or services (hereinafter “products”) by automatically selecting advertising messages and product versions that reflect user preferences in an interactive media system that may include interactive TV or streaming media. Advertising message and product version selection may employ a database of user preferences including history information of past purchases. Selection may also employ demographic information. Preference information may be stored for a number of viewers and may be selected through a menu, or may be selected in response to an input device that includes a user identity function. Viewer identity may be determined in part by Internet address, set top box identifier, service provider or other information.

The present invention may therefore comprise a method of offering a product for sale on an interactive media system comprising: displaying an advertising message comprising at least one visual image, receiving a response from a viewer to the advertising message, checking if a plurality of versions exist for a product contained within the product advertising message, comparing the plurality of versions with preference information associated with the viewer, selecting at least one version of the plurality of versions using the preference information, displaying information describing the one version, and displaying a purchasing icon.

The present invention may further comprise a system for advertising and purchasing products and services on an interactive television system comprising: a first database that contains customer identification and preference information, a second database containing information describing a plurality of products contained in each of a plurality of advertisements, a first program that receives a user response to an advertisement and that checks for versions of a product associated with the advertisement and selects one version of the product using the preference information if a plurality of versions of the product exist and selects the one version of the product if a plurality of versions of the product do not exist,

a second program that presents information of the one version to a viewer, and a third program that produces a purchasing icon.

The present invention may be employed in interactive television and streaming media advertising and purchasing. A television, set top box, or personal computer receives broadcast signals containing advertising messages from a television station, cable operator, Internet service provider or other broadcast source. Advertising messages may employ a number of formats including full screen commercials, partial screen commercials, scrolling messages, overlays, logos, icons and on-content interactive access points, described below, which are otherwise referred to as hotspots. Partial screen commercials may format the display area to contain a first portion with a displayed video program and a second portion that may contain advertising. Scrolling messages may appear across the bottom of a displayed image, in a manner similar to that of weather notices, for example. Overlays, logos, icons and hotspots may be used to indicate that a displayed item may be purchased. For example, if a basketball program is broadcast, a logo for an athletic shoe may appear on the screen, indicating that a viewer may order products or obtain information by selecting the logo. Further, a promotion for an upcoming program may contain icon based merchandising. For example, a broadcaster may display a promotion for a movie that will be presented in 30 minutes, and an icon of a pizza may be displayed with the promotion to suggest to the viewer that a pizza ordered now will arrive in time to watch the movie.

On content interactive access points (hotspots) and visual cuing may be employed to indicate that a displayed item may be purchased, such as disclosed in U.S. non-provisional patent application Ser. No. 10/041,881 entitled “Creating On Content Enhancements” filed Oct. 24, 2001 by Gary Rasmussen et al, and as disclosed by U.S. provisional application Ser. No. ______ entitled “Tracking Moving Objects On Video With Interactive Access Points” filed Feb. 6, 2002 by Steven O. Markel. A cursor associated with a pointing device or remote control unit may change appearance to indicate that a displayed item may be purchased. Also, a visual cue may be presented to indicate that a displayed item may be purchased. For example, a displayed image depicting a man wearing a sport coat may include a twinkling star displayed at some position on the sport coat to indicate that the coat may be purchased. The twinkling star may then dissolve to an icon for a clothing retailer, which a user may then select for purchase or product information, or the user may select an area of the screen where the coat is displayed to obtain product and purchasing information. Cuing techniques include highlighting, outlining, color shift, arrows and other indicators, for example, with the purpose of identifying a displayed item. For example, a picture of an automobile may be accompanied with local dealer information. Dealer information may also include services provided by the dealer. Advertising information may also be rendered in conjunction with a displayed image such that an advertising message or icon is conformally mapped to a surface. A background portion of a sports stadium, such as a wall or solid fence, for example, may contain advertising messages. Images may also be mapped to automobiles, appliances, shirts or other displayed objects. Emerging technology provides an opportunity to display advertising and other messages in new and unforeseen venues, providing increased opportunity to reach consumers.

Hotspots and visual cuing may be used in conjunction with entertainment programs, or may be used with advertising wherein a common advertising image may be employed in different markets, such as different cities for example, and hotspots or cues configured to route purchase and information selections to local vendors. Visual indications of an advertising message may be accompanied by an audio signal.

The present invention may additionally comprise a method of advertising and purchasing products and presented on an interactive media system comprising: producing a screen display that includes an image associated with a product for sale, producing an indicator that a product is associated with the object, receiving an input from a viewer, identifying the viewer, checking for preference information associated with the viewer, checking if a plurality of versions of the product exist, selecting at least one version of the plurality of versions using the preference information if a plurality of versions of the product exist and selecting one version of the product if a plurality of versions do not exist, displaying information describing the one version; and displaying a purchasing icon.

A response to an advertising message is routed to a computer containing a software program to process product ordering. Routing may comprise cable television upstream communication, Internet communication, telephone, satellite or other methods. Preference information may be contained within the display apparatus or within a computer containing a software program to process product ordering. Preference information may include descriptions of user parameters such as shirt size and color choice, for example. Preference information may also include past purchase information such as pizza ingredients, or the format of products ordered such as CD or tape, DVD or videocassette products, for example.

In a first embodiment of the present invention, when advertising is presented, a check is performed to determine if the advertised product or service is available in different versions or product varieties. If the product is offered in different versions or varieties, the versions or varieties are compared with stored preference information and a product version that matches or most closely matches user preferences may be displayed along with an icon, which the user may select using a remote control unit, mouse or other device. The icon may be used to submit an order for purchase using information identifying the product selected from the aforementioned comparison with user preference information, along with other stored information that may include credit card number and shipping address, allowing a single response action to purchase a product selected using preference information.

In a second embodiment of the present invention, a check to determine if the advertised product is available in different version or varieties is performed when a user input is received. If the product is offered in different versions or varieties, the versions or varieties are compared with stored preference information and a product version that matches or most closely matches user preferences may be displayed along with an icon, which the user may select using a remote, mouse or other device. The icon may be used to submit an order for purchase using information identifying the product selected from the aforementioned comparison with user preference information, along with other stored information that may include credit card number and shipping address, for example. If preference, billing or shipping information is not present, the user may be prompted to enter such information.

The present invention may further yet additionally comprise a system for advertising and purchasing products and services presented on an interactive television system comprising: a first database that contains customer identification and preference information, a second database containing information describing a plurality of product advertisements, a first program that associates one product advertisement of the plurality of product advertisements with a displayed object presented to a viewer and that produces a visual indicator, a second program that checks for versions of a product associated with the one product advertisement and selects at least one version of the product using the preference information if a plurality of versions of the product exist and selects the one version of the product if a plurality of versions of the product do not exist, and a third program that produces a purchasing icon.

Preference information may also extend to suppliers and shipping addresses. If a user orders a certain type of product, such as business supplies, the system of the present invention may be configured to specify a shipping address or a billing address that corresponds to the user's place of business. If the user orders products that are available from a supermarket, for example, the system of the present invention may route an order for product or products to a preferred supermarket. Preference information for a user may also include trends such as pizzas ordered on Thursdays are pepperoni and pizzas ordered on Saturday are ham and pineapple.

The method and system of the present invention may operate as part of, or in conjunction with, systems and methods that provide targeted advertising in which advertising messages may be selected or tailored prior to broadcast in response to user information. Preference information may be stored on user equipment or may be stored on other equipment such as that of the broadcaster or advertiser, for example. Further, the present invention and preference information thereof may be integrated with customer relationship management system (CRM) and data warehousing products such as those from NCR Corporation. A response to an advertisement may be tailored to a user, as might be identified by internet address, personalized remote control indicator such as disclosed in U.S. Non-provisional patent application Ser. No. 09/9441,148 entitled “Personalized Remote Control,” filed Aug. 27, 2001, by Thomas Huber, et al., or other methods, and include items that the user may be more likely to purchase as may be determined from both preference information for the user and trend information for similar users.

### BRIEF DESCRIPTION OF THE DRAWINGS

In the drawings;

FIG. 1 depicts a flowchart for selecting purchasing systems.

FIG. 2 depicts a flowchart for single product variety purchasing.

FIG. 3 depicts a flowchart for preference based purchasing.

FIG. 4 depicts a product advertising process employing advertising type selection and customer preference selection.

FIG. 5 depicts an advertising process employing displayed object association.

FIG. 6 depicts an advertising process employing both demographic and preference information prior to broadcast.

### DETAILED DESCRIPTION OF THE INVENTION

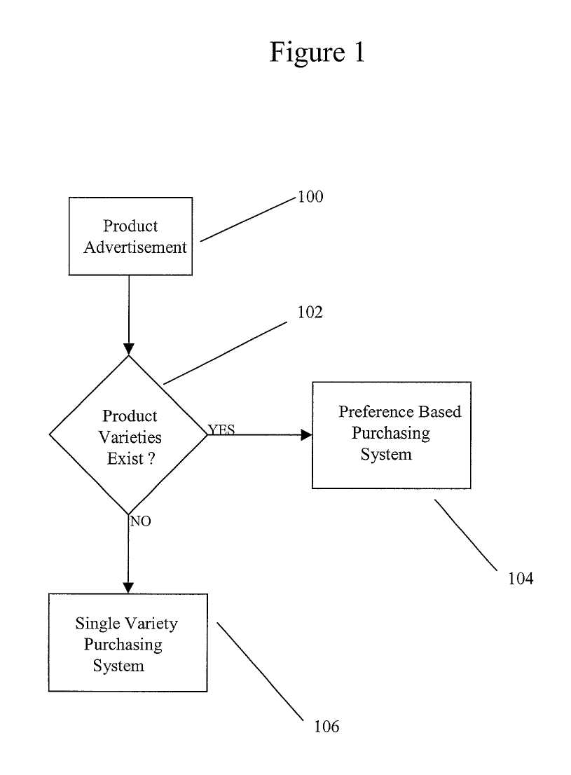

FIG. 1 depicts a flowchart for selecting purchasing systems. When product advertisement 100 is displayed, a software program performs product varieties check 102 to determine if the advertised product is available in different varieties or versions. If the product is available only in a single version or variety, product varieties check 102 results in single variety purchasing system 106 being selected. If the product is available in more that one variety, product varieties check 102 results in preference based purchasing system 104 being selected.

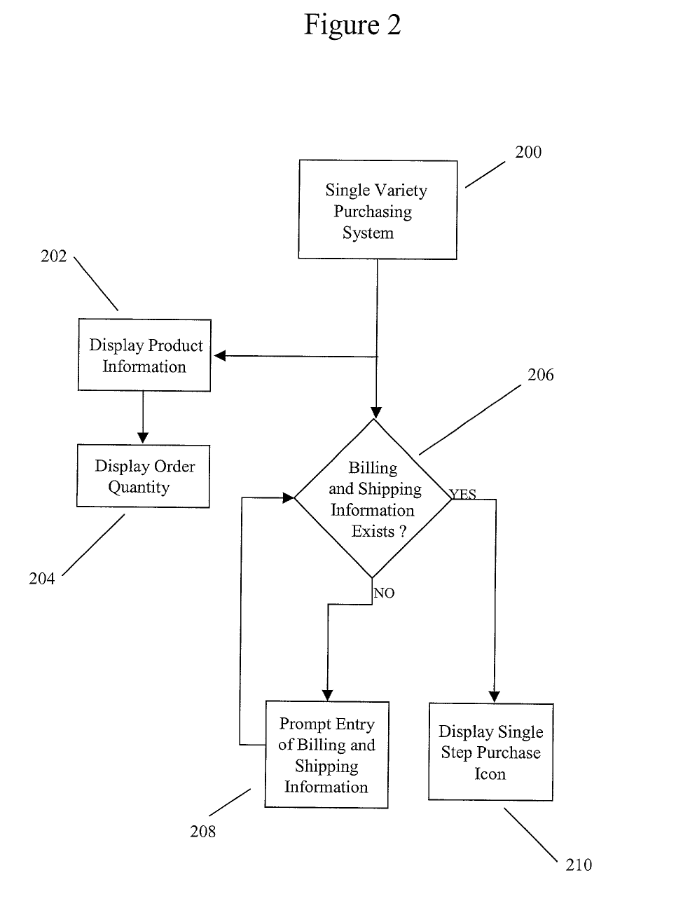

FIG. 2 depicts a flowchart for single product variety purchasing. Single variety purchasing system 200 performs tasks display product information 202 and display order quantity 204. Billing and shipping information check 206 is performed to determine if billing and shipping information exists for the user. If billing and shipping information does not exists, billing and shipping information entry 208 is performed. If the result of billing and shipping information check 206 is that billing and shipping information does exist, the system performs step 210 to display a single step purchase icon such that a product may be purchased with a single user input such as a click of a mouse button.

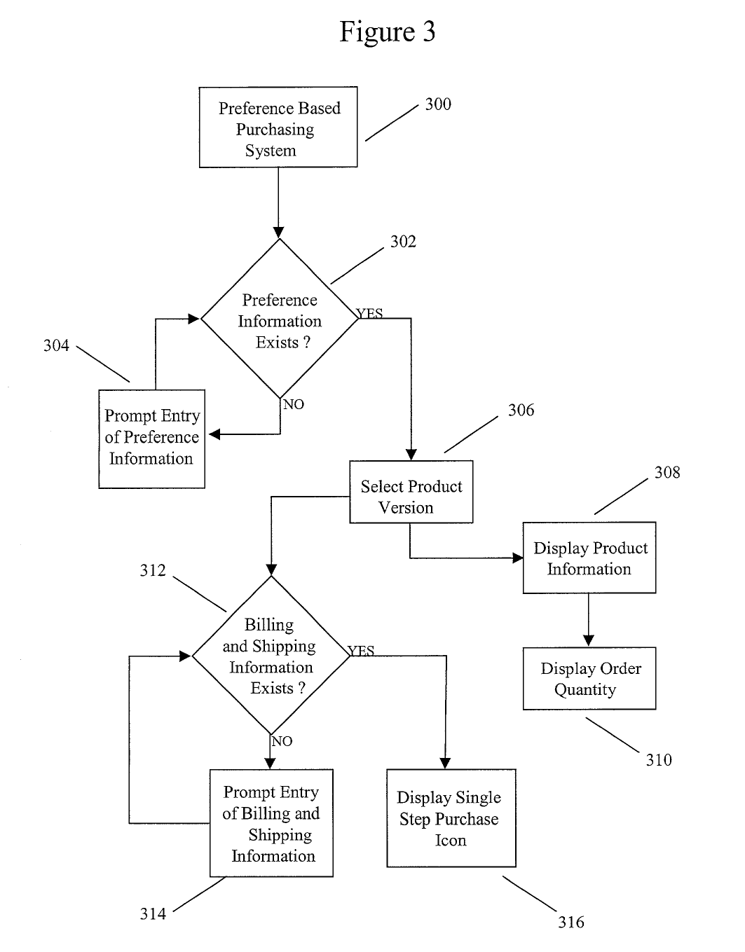

FIG. 3 depicts a flowchart for preference based purchasing. Preference based purchasing system 300 performs preference information check 302. If preference information does not exist, the system performs preference information prompt 304 to have the user enter preference information. If the result of preference information check 302 is that preference information does exist, the system proceeds to select product version 306 in which a product that matches or most closely matches the user preference is selected. The system then proceeds to display product information 308 and display order quantity 310. Billing and shipping information check 312 is performed determine if billing and shipping information exists for the user. If billing and shipping information does not exists, billing and shipping information entry 314 is performed. If billing and shipping information check 312 finds billing and shipping information does exists, the system performs display single step purchase icon 316, allowing the user to purchase the selected version of the product with a single action.

The above figures illustrate advertising and purchasing methods that may result in higher customer response by offering versions of products that reflect the customer's preferences. In addition to offering versions of products reflecting customer preference, the present invention may be employed to select product types suited to the customer. The selection of advertisements may employ demographic information, preference information, purchase history, and other customer information. Purchase history may be employed to schedule services. For example, advertisements for oil changes, carwashes, and other services may be displayed if a predetermined interval has elapsed since the last service. An icon may be displayed in conjunction with a program containing an automobile to indicate the availability of services and that the viewer's vehicle may be due for service. Advertisement type may also reflect vehicle information wherein advertisements are tailored to the consumer's vehicle. New truck owners, for example, may be presented advertisements for bed liners and toppers (bed covers) wherein the colors and styles presented employ customer preferences, reflecting the color and model of the consumer's truck. Additionally, items that complement previous purchases, such as furniture, clothing, and appliances, for example, may be presented in advertisements. The method of the present invention may be employed to select both the type of advertisement presented and the variety of the products offered. Advertisements may also include coupons to encourage the viewer to participate in a product offering.

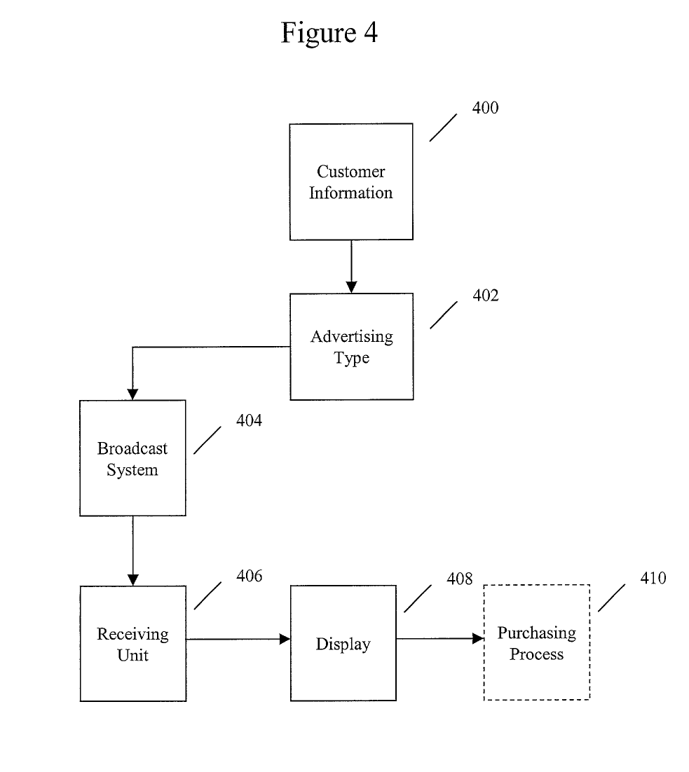

FIG. 4 depicts a product advertising process employing advertising type selection and customer preference selection. At step 400, customer information is accessed to select advertisement type 402 suited to the customer. Selection may employ demographic information such as age, marital status, types of vehicles, past purchase history and other information. Computers, located at a broadcast facility or at a remote location, may access a database of customer information to associate advertisements with particular individuals, families, or groups of individuals. At step 404 the selected advertisement is broadcast to receiving unit 406. Receiving unit may comprise a set top box, satellite receiver, personal computer or other device. Receiving unit 406 provides output to display 408 where a potential customer may view the advertisement. If the customer responds to the advertisement, purchasing process 410 employs some or all of the steps depicted in FIGS. 1-3.

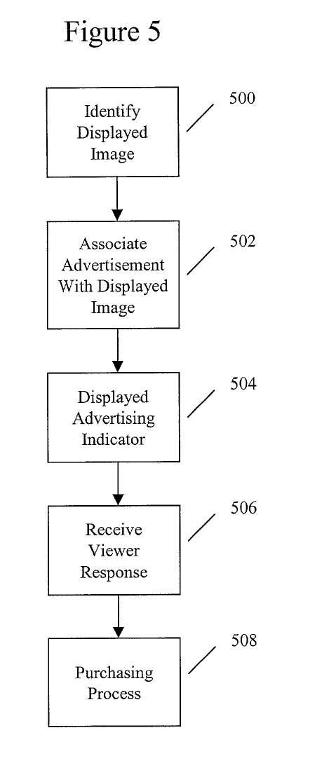

FIG. 5 depicts an advertising process employing displayed object association. Through image recognition, either manual or automated, a displayed image in a program or advertisement is associated with a product offering. A program or advertisement may contain a plurality of images with which products may be associated. A product offering may be indicated by the display of an icon on or in proximity to the recognized image, by visually altering the image, or by displaying text or graphics on or in proximity to the image wherein the text or graphics may be warped to conform to the surface of the image. At step 500 a displayed image is identified. At step 502, an advertisement is associated with the displayed image. At step 504, an advertising indicator is displayed. Such display may comprise combining the indicator with a program or advertisement prior to broadcast, or may employ combination or overlay at a receiving unit. At step 506 a viewer response to the advertisement is received and at step 508 a purchasing process is invoked. The purchasing process may employ any of the methods previously described.

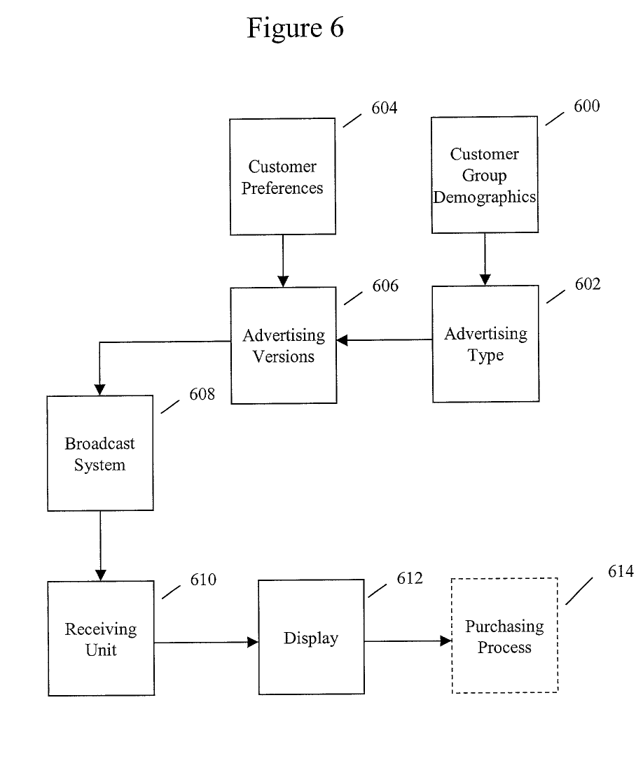

FIG. 6 depicts an advertising process employing both demographic and preference information prior to broadcast. Demographic information 600 is employed to select advertisement type 602. Demographic information 600 may be specific to the customer or may be information for a group of which the customer may be associated. Customer preference information 604 is then employed to select advertising versions 606 of advertisement type 604. The advertisement is broadcast at step 608 to receiving unit 610 and is displayed at step 612. If the customer responds to the advertisement, purchasing process 614 is invoked. The purchasing process may employ methods shown in FIGS. 1-3.

Advantageously, the present invention provides a simplified and more convenient advertising and purchasing environment wherein product advertisements most likely of interest to the customer are presented and the purchasing process is simplified through retention of billing and shipping information. Customer purchasing may employ on-screen selection of a purchase icon that may provide single click purchasing. Other purchasing methods may be employed within the scope of the present invention. For example, selection of a product icon may result in the display of a telephone number and a product code such that the customer may order the product or service by dialing the telephone number, entering the product code, and entering a personal security code. The purchasing icon associated with the present invention may also be employed to display special offers, discounts or other information such as loyalty programs, for example, where the customer may be offered a reduced price if a number of items have been purchased form the same retailer or from the same manufacturer.

The present invention is applicable to interactive media systems such as televisions, computers, satellite receivers or other systems connected to a network such as a cable network, satellite network, terrestrial broadcast network, the Internet or other networks wherein television or streaming media programs and advertisements may be received and a response from a viewer may be communicated to a processing system.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

We claim:

1. A method of offering a product for sale presented on an interactive media system comprising:
displaying an advertising message on said interactive media system comprising at least one visual image of said product;
receiving a response from a viewer to said advertising message;
checking if a plurality of versions exist for said product contained within said product advertising message;
comparing said plurality of versions with preference information associated with said viewer;
selecting at least one version of said plurality of versions using said preference information;
displaying information describing said one version; and
displaying purchasing information.

2. The method of claim 1 wherein said step of displaying a purchasing icon further comprises:
checking if billing and shipping information exist for said viewer; and
displaying a single step purchase icon if said billing and shipping information exists.

3. The method of claim 1 further comprising:
displaying said billing and shipping information.

4. The method of claim 1 wherein said icon is combined with a displayed image prior to broadcast of said image.

5. The method of claim 1 wherein said icon is combined with a displayed image in a receiving unit.

6. A system for advertising and purchasing products presented on an interactive television system comprising:
a first database that contains customer identification and preference information;
a second database containing information describing said products contained in at least one advertisement;
a first program that receives a user response to said advertisement presented on said interactive television system and that checks for versions of said products associated with said advertisement and selects one version of said products using said preference information if a plurality of versions of said products exist and selects the one version of said products if a plurality of versions of the product do not exist;
a second program that presents information of said one version to a viewer; and
a third program that produces purchasing information.

7. The system of claim 6 wherein said third program further comprises:
a routine that checks if billing and shipping information exists for said viewer and that produces a single step purchasing icon if said billing and shipping information does exist.

8. A method of offering a product for sale presented on an interactive media system comprising:
identifying a viewer;
accessing preference information for said viewer;
accessing information for said product that is advertised on said interactive media system;
checking if a plurality of versions exist for said product;
selecting at least one version of said plurality of versions using said preference information if said plurality of versions exist and selecting the one version of the product if only one version exists;
displaying information describing said one version; and
displaying a purchasing icon.

9. The method of claim 8 wherein said step of displaying a purchasing icon further comprises:
checking if billing and shipping information exist for said viewer; and
displaying a single step purchase icon if said billing and shipping information exists.

10. A system for advertising and purchasing products presented on an interactive television system comprising:
a first database that contains customer identification and preference information;
a second database containing information describing said products contained in an advertisement;
a first program that checks for versions of said products associated with said advertisement on said interactive television system and selects one version of said products using said preference information if a plurality of versions of said products exist and selects the one version of the said products if a plurality of versions of said product do not exist;
a second program that presents information of said one version to a viewer; and
a third program that produces a purchasing icon.

11. The system of claim 10 wherein said third program further comprises:
a routine that checks if billing and shipping information exists for said viewer and that produces a single step purchasing icon if said billing and shipping information does exist.

12. A method of advertising and selling products presented on an interactive media system comprising:
generating an interactive access point on said products displayed on said interactive media system;
receiving an input from a viewer in response to said viewer activating said interactive access point;
identifying said viewer from said input;
checking for preference information associated with said viewer;
checking if a plurality of versions of said product exist;
selecting at least one version of said plurality of versions using said preference information if a plurality of versions of said product exist and selecting one version of said product if a plurality of versions do not exist;
displaying information describing said one version; and
displaying purchasing information.

13. The method of claim 12 wherein said step of displaying a purchasing icon further comprises:
checking if billing and shipping information exist for said viewer; and
displaying a single step purchase icon if said billing and shipping information exists.

14. A method of advertising and selling a product on an interactive media system comprising:
identifying a viewer;
accessing demographic information associated with said viewer;
selecting an advertisement type employing said demographic information;
selecting one advertisement that corresponds to said advertisement type from a plurality of advertisements;
associating said one advertisement with said product contained within a displayable image;
producing an interactive access point that is associated with said product, said interactive access point providing an interactive link for allowing said viewer to purchase said product;
receiving a user response to activation of said interactive access point;
checking for preference information associated with said viewer;
checking if a plurality of versions of said product exist;
selecting at least one version of said plurality of versions using said preference information if a plurality of versions of said product exist and selecting one version of said product if a plurality of versions do not exist;
displaying information describing said one version; and
displaying purchasing information.

15. The method of claim 14 wherein said step of displaying a purchasing icon further comprises:
checking if billing and shipping information exist for said viewer; and
displaying a single step purchase icon if said billing and shipping information exists.

16. The method of claim 13 wherein said step of producing an indicator further comprises:
changing the appearance of said object.

17. The method of claim 13 wherein said step of producing an indicator further comprises:
displaying an icon in conjunction with said object.

18. The method of claim 13 wherein said step of producing an indicator further comprises:
displaying text over said object.

19. The method of claim 13 wherein said step of producing an indicator further comprises:
displaying a graphic image over said object.

20. The method of claim 17 wherein said step of displaying text further comprises:
warping said text to conform to the shape of said object.

21. The method of claim 18 wherein said step of displaying a graphic image further comprises:
warping said graphic image to conform to the shape of said object.

22. A system for advertising and purchasing a product presented on an interactive media system comprising:
a first database that contains customer identification and preference information;
a second database that contains customer demographic information;
a third database containing information describing a plurality of product advertisements;
a first program that associates a product advertisement presented on said interactive media system of said plurality of product advertisements for said product with said customer using said demographic information;
a second program that checks for versions of said product associated with said product advertisement and selects at least one version of said product using said preference information if a plurality of versions of said product exist and selects the one version of said product if a plurality of versions of the product do not exist; and
a third program that produces purchasing information.

23. The system of claim 22 wherein said third program further comprises:
a routine that produces a first purchasing icon if billing and shipping information exists for said customer and that produces a second purchasing icon if said billing and shipping information does not exist;

24. The system of claim 22 wherein said first purchasing icon is a single step purchasing icon.

25. The system of claim 22 wherein said first database further comprises:
information of past purchases by said customer.

26. The system of claim 22 further comprising:
a program that determines a price for said product employing loyalty information.

27. The system of claim 26 wherein said loyalty information further comprises:
a history of past purchases of products from the same retailer.

28. The system of claim 26 wherein said loyalty information further comprises:
a history of past purchases of products from the same manufacturer.

29. A system for advertising and selling a product presented on an interactive television system comprising:
a first database that contains customer identification and preference information;
a second database containing information describing a plurality of product advertisements;
a first program that associates one product advertisement of said plurality of product advertisements with said product presented to a viewer on said interactive television system and that produces a visual indicator;
a second program that checks for versions of said product associated with said one product advertisement and selects at least one version of said product using said preference information if a plurality of versions of said product exist and selects the one version of said product if a plurality of versions of the product do not exist; and
a third program that produces a purchasing icon.

30. The system of claim 29 wherein said third program further comprises:
a routine that produces a first purchasing icon if billing and shipping information exists for said customer and that produces a second purchasing icon if said billing and shipping information does not exist;

31. The system of claim 29 wherein said second program operates in response to an input from said viewer.

32. A method of offering a product for sale in conjunction with a motion video program presented on an interactive media system comprising:
displaying a promotion for a second motion video program to be presented at a predetermined time;
identifying a viewer;
accessing preference information for said viewer;
accessing information for a product to be advertised;
checking if a plurality of versions exist for said product;
selecting at least one version of said plurality of versions using said preference information if said plurality of versions exist and selecting the one version of said product if only one version exists;
displaying information describing said one version at a time that allows delivery of said product prior to presentation of said second motion video program; and
displaying a purchasing icon.

33. The method of claim 7 wherein said step of displaying a purchasing icon further comprises:
checking if billing and shipping information exist for said viewer; and
displaying a single step purchase icon if said billing and shipping information exists.
